(19) United States
(12) Patent Application Publication
(10) Pub. No.: US 2021/0071919 A1
(43) Pub. Date: Mar. 11, 2021

(54) Heat Exchanger System

(71) Applicant: Robert Bosch GmbH, Stuttgart (DE)

(72) Inventors: Holger Wuest, Stuttgart (DE); Andreas Burghardt, Stuttgart (DE)

(21) Appl. No.: 16/962,408

(22) PCT Filed: Jan. 3, 2019
(86) PCT No.: PCT/EP2019/050062

§ 371 Date: Jul. 15, 2020

(30) Foreign Application Priority Data
Jan. 18, 2018 (DE) 10 2018 200 792.6

(51) Int. Cl. F25B 23/00; F03G 7/08

(52) U.S. Cl. CPC F25B 23/00; F03G 7/08

(57) ABSTRACT

A heat exchanger system includes a heat exchanger device, which has elastocaloric elements made of elastocaloric material and is designed to move the elastocaloric elements, as a result of which said elements are deformed, so that an elastocaloric effect is achieved. The heat exchanger system further includes a vibrating unit, which generates mechanical vibrations, and a vibration transfer device arranged between the vibrating unit and the heat exchanger device, and which transfers the vibrations from the vibrating unit into the elastocaloric elements so that the elastocaloric elements move.

The invention relates to a heat exchanger system with a vibration transmitter using the elastocaloric effect. In addition, the invention relates to a heat pump with such a heat exchanger system.

### PRIOR ART

The elastocaloric effect describes an adiabatic temperature change of a material when the material is subjected to a mechanical force and, for example, is deformed. The mechanical force or the deformation causes a conversion of the crystal structure, also called phase, in the material. The phase conversion leads to an increase in the temperature of the material. If the heat liberated in the process is dissipated, the temperature is reduced and the entropy decreases. If the mechanical force is then removed, a reverse phase conversion (reconversion) is in turn caused, leading to a reduction of the temperature of the material. If heat is then supplied again to the material, the entropy increases again.

After the approximately adiabatic phase conversion, the temperature is above the starting temperature. The heat which has been produced in the process can be dissipated, for example, to the environment and the material then takes on the ambient temperature. If the phase reconversion is then initiated, by the mechanical force being reduced to zero, a lower temperature arises than the starting temperature. Temperature differences between the maximum temperature after the phase conversion and minimum temperature after the reconversion (with the heat having been output previously) of up to 40° C. can be achieved.

Materials at which the elastocaloric effect can be determinated are referred to elastocaloric materials. Such elastocaloric materials are, for example, shape memory alloys which have superelasticity. Superelastic alloys are distinguished in that they automatically return again into their original shape even after severe deformation. Superelastic shape memory alloys have two different phases (crystal structures): austenite is the phase which is stable at room temperature and martensite is stable at lower temperatures. A mechanical deformation causes a phase conversion from austenite to martensite which results in an adiabatic rise in temperature. The increased temperature can now be output to the environment in the form of heat, which leads to a decrease in the entropy. If the elastocaloric material is relieved of load again, a reconversion from martensite to austenite takes place and, in association therewith, the temperature is adiabatically reduced.

Two typical heat exchanger devices are described below: in one arrangement, a biconvex heat-conducting element, i.e. a heat-conducting element which is convex on both sides is arranged at a distance between two planar heat-conducting elements. An elastocaloric element is in each case stretched in the intermediate spaces between the planar heat-conducting elements and the biconvex heat-conducting element. The elastocaloric elements are connected to one another and can be moved together. They are arranged here in such a manner that an elastocaloric element is in each case deformed by the biconvex heat-conducting element, which causes a tensile stress on the convex outer side of the metal sheet and a compressive stress on the concave inner side. No stress occurs exclusively in what is referred to as the neutral fiber. At the same time, the other elastocaloric element returns again because of its superelasticity into its planar original shape and enters into contact flat with the planar heat-conducting element. Should the deformation back into the original shape be incomplete, residual deformation back takes place upon contact with the planar heat-conducting element. By means of this arrangement, heat is transported from the planar heat-conducting elements to the biconvex heat-conducting element.

The heat is typically transported away, or conveyed toward, the heat-conducting elements by a heat transport means, for example a coolant which is in contact with the heat-conducting elements. In order to convey the heat transport means, use is conventionally made of a compressor or a pump. Said conveying component generates mechanical vibrations during operation. In this document, components which generate mechanical vibrations are referred to as vibrating units.

### DISCLOSURE OF THE INVENTION

A heat exchanger system is proposed. The system comprises a heat exchanger device which is known per se and which has elastocaloric elements made of elastocaloric material. The heat exchanger device is configured to move the elastocaloric elements. Movement of the elastocaloric elements causes the latter to be deformed. The deformation triggers the occurrence of the elastocaloric effect in the elastocaloric material, leading to heating of the elastocaloric elements. If the elastocaloric elements move back again, the elastocaloric elements cool during the reverse shaping.

In addition, the proposed heat exchanger system has a vibrating unit. Said vibrating unit is, for example, a compressor or a pump for conveying a heat transport means, for example a coolant or the like. Typically, a vibrating unit is already present in conjunction with the heat exchanger device, in order to remove the heat converted by the elastocaloric effect from the heat exchanger device. The vibrating unit generates mechanical vibrations during its operation.

Furthermore, a vibration transmitter is provided which is arranged between the vibrating unit and the heat exchanger device. The vibration transmitter is configured to transmit the vibrations of the vibrating unit to the elastocaloric elements of the heat exchanger device such that the elastocaloric elements move. The vibrations transmitter can transmit the vibration solely to the elastocaloric elements, solely to the heat-conducting elements or both to the elastocaloric elements and to the heat-conducting elements, which leads in each case to the movements already described above of said components. The vibration transmitter makes it possible to pass on the vibrations of the vibrating unit, which is typically already present, in usable form as movement to the elastocaloric elements. An additional drive for the elastocaloric elements can thereby be omitted.

The vibration transmitter primarily transmits vibrations, the deflection of which points in the direction of movement of the elastocaloric elements or of the heat element. Since the vibrating unit typically generates vibrations in different directions or even in all directions simultaneously, it can be provided to arrange the elastocaloric elements around the vibrating unit in the different directions, in particular in all the directions in which the vibrating unit generates vibrations.

According to one aspect, the heat exchanger device can additionally have heat-conducting elements. During the movement of the elastocaloric elements, the elastocaloric elements can be moved toward the fixed heat-conducting elements and/or away from the latter, or both the elastocaloric elements and the heat-conducting elements can be moved in the direction of the other in each case and/or in opposite directions. The movement of the elastocaloric elements brings the elastocaloric elements into contact with the heat-conducting elements and the elastocaloric elements are deformed. If the elastocaloric elements are moved back again, the elastocaloric elements cool during the reverse shaping. In addition, the vibration transmitter transmits the vibrations of the vibrating unit at least to the elastocaloric elements such that the elastocaloric elements and the heat-conducting elements move toward one another and/or away from one another. The vibration transmitter can transmit the vibration solely to the elastocaloric elements or both to the elastocaloric elements and to the heat-conducting elements, which in each case leads to the movements already described above of said components.

According to one aspect, the vibration transmitter comprises mechanical transmission elements, such as, for example, spring elements or other mechanical transmission elements that have suitable rigidity. The vibrations can be transmitted linearly to the elastocaloric element via the mechanical transmission elements. This is particularly advantageous if the vibrations are regular, i.e. have a constant amplitude and a constant frequency. This is the case, for example, if the vibrating unit is operated at a working point in a stationary manner.

Furthermore, irregular vibrations of the vibrating unit, the amplitude and/or frequency of which vary, can also be made usable for the heat exchanger device. For the operation of the elastocaloric elements, a designated travel distance and a designated transmitted force should be maintained. In addition, the vibration transmitter can be configured to convert the frequency of the mechanical vibrations of the vibrating unit into a frequency suitable for operating the heat exchanger device. The frequency can preferably be converted into a resonant frequency of the heat exchanger device, with which resonant frequency a particularly a high degree of effectiveness can be achieved. Measures are presented below with which the designated travel distance and the designated force can be achieved from the irregular vibrations of the vibrating unit, and the frequency of the vibrations can be converted into a frequency suitable for operating the heat exchanger device.

The vibration transmitter can comprise a travel distance limiter, for example a stop, which limits the deflection of the vibrations to the travel distance provided for operating the heat exchanger device. As a result, the same travel distance can be achieved even with irregular vibrations.

In addition, the vibration transmitter can comprise a damping element, for example a spring or a hydraulic element, in order to damp the forces which arise during the transmission of the vibration and which can occur in differing strengths depending on irregular amplitudes of the vibration. As a result, differently formed deformations of the elastocaloric elements can be prevented.

Sensors can preferably be provided which carry out measurements at the vibrating unit and/or at the vibration transmitter. Examples of measurements are listed below, with individual, a plurality of and/or further measurements that are not listed here being able to be carried out:
a measurement of the frequency of the mechanical vibrations of the vibrating unit;
a measurement of the force transmitted by the vibrating unit;
a measurement of the deformation exerted on the elastocaloric elements;
a measurement of the travel distance.

The measurements can be used in order to set or optionally to adjust the operation of the heat exchanger system to these parameters. For example, the cycles in which the heat transport means is conveyed can be set or optionally adjusted synchronously to the vibrations which have been emitted by the vibrating unit and transmitted, and in the process optionally changed, by the vibration transmitter.

The vibration transmitter can comprise means for changing a pressure within the vibration transmitter, i.e. in particular a pump, with which means the irregular vibrations can be used for building up a negative pressure or for building up a positive pressure. The negative pressure or the positive pressure can be built up step by step, wherein each vibration can contribute individually to building up the negative pressure or the positive pressure and controlled, for example, via a valve and/or travel distance limiter. The negative pressure or positive pressure which is built up can then act on a linearly moveable transmission element which is connected to the elastocaloric elements. In the event of the negative pressure, the transmission element can move into a volume in which the negative pressure is built up and, in the case of the positive pressure, can move out of a volume in which the positive pressure is built up. The transmission element transmits its movement, which is triggered by the pressure, to the elastocaloric elements. The specification of the pressure makes it possible to realize the force provided for operating the heat exchanger device and the resulting deformation of the elastocaloric elements and, by the buildup of the pressure step by step, the suitable frequency. In addition, it can be provided that, after the desired pressure has been built up and the provided force has thereby acted on the elastocaloric elements, the pressure is dissipated in a controlled manner via a relief valve. The elastocaloric elements can thereby return again to their original shape. The sequence between building up and dissipating of the pressure can be carried out cyclically and optionally controlled with the aid of a pressure sensor and/or the abovementioned sensors.

The vibration transmitter can comprise means for converting the vibrations into electrical work. For this purpose, the vibration can be transmitted to a permanent magnet which is enclosed by a coil and which then carries out periodic movements into the coil and out of the coil. The electrical work can be stored in the form of electrical energy in an energy store, for example, in a battery. In addition, the vibration transmitter can comprise at least one actuator which then converts the electrical work into a movement of the elastocaloric elements.

Furthermore, a heat pump is proposed which has the abovementioned heat exchanger system. The abovementioned features and advantages of the device also apply to the heat pump. The heat exchanger system makes it possible for an additional drive within the heat pump to be omitted, and therefore said heat pump can be realized more compactly and cost-effectively.

The heat pump can be used, for example, in refrigerators or freezers, in the temperature management of Li ion batteries and solid state batteries and for heating or cooling the passenger compartment of vehicles, etc., to mention just a few examples.

### BRIEF DESCRIPTION OF THE DRAWINGS

Exemplary embodiments of the invention are illustrated in the drawings and explained in more detail in the description below.

FIG. 1 shows a schematic illustration of an exemplary embodiment of the heat exchanger system according to the invention.

FIG. 2 shows a schematic illustration of a first embodiment of a vibration transmitter from FIG. 1.

FIG. 3 shows a schematic illustration of a second embodiment of the vibration transmitter from FIG. 1.

FIG. 4 shows a schematic illustration of a third embodiment of the vibration transmitter from FIG. 1.

FIG. 5 shows a schematic illustration of a fourth embodiment of the vibration transmitter from FIG. 1.

### EXEMPLARY EMBODIMENTS OF THE INVENTION

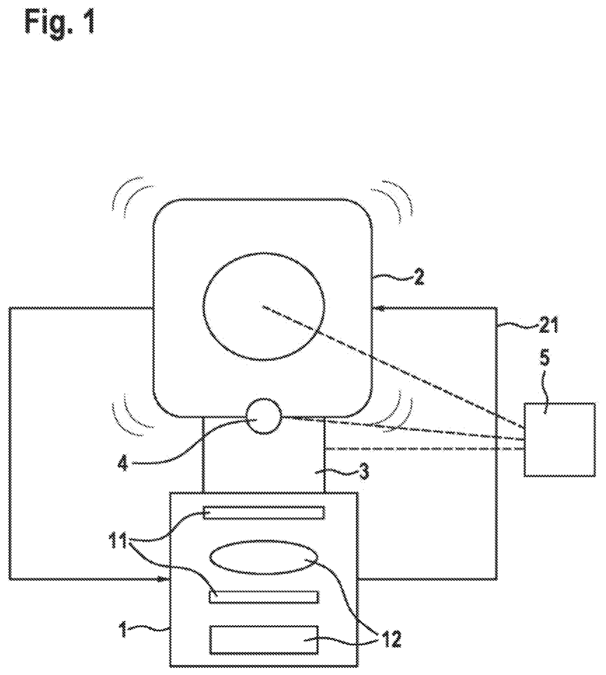

FIG. 1 shows a schematic illustration of an embodiment of the heat exchanger system according to the invention which comprises a heat exchanger device 1. The heat exchanger device 1 has elastocaloric elements 11 made of elastocaloric material, and heat-conducting elements 12. In this embodiment, the elastocaloric elements 11 are moved cyclically toward the fixed heat-conducting elements 12, as a result of which the elastocaloric elements 11 come into contact with the heat-conducting elements 12 and are deformed such that an elastocaloric effect is achieved, and is subsequently moved away from the heat-conducting elements 12. In further exemplary embodiments, the heat-conducting elements 12 can be moved and the elastocaloric elements 11 remain fixed, or both the elastocaloric elements 11 and the heat-conducting elements 12 can be moved.

In addition, the heat exchanger system has a vibrating unit 2, such as, for example, a compressor or a pump for conveying a heat transport means 21, which unit generates mechanical vibrations. Firstly, if the vibrating unit 2 is operated at a working point in a stationary manner, regular vibrations with a constant amplitude and frequency can be generated and, secondly, irregular vibrations, the amplitude and frequency of which vary, can be generated.

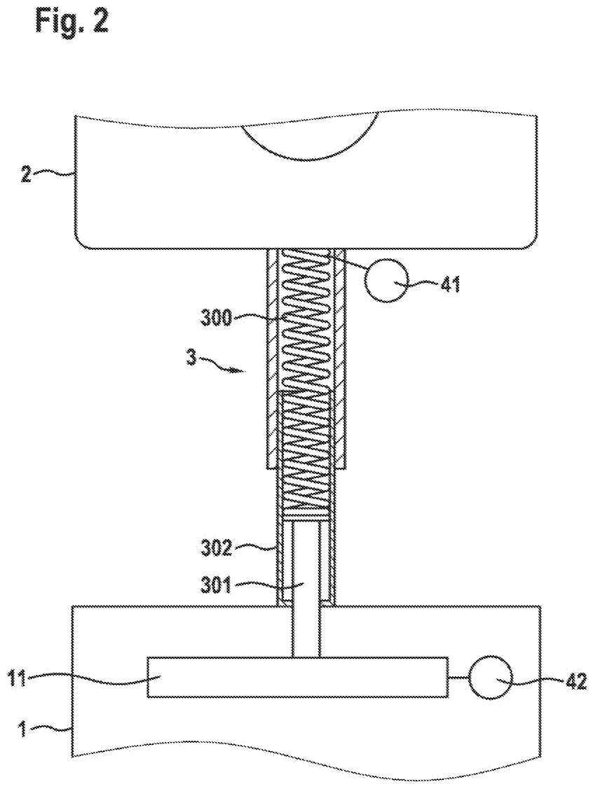

According to the invention, a vibration transmitter 3 is to be arranged between the vibrating unit 2 and the heat exchanger device 1. The vibration transmitter 3 is configured to transmit the mechanical vibrations of the vibrating unit 2 to the elastocaloric elements 11 or/and to the heat-conducting elements 12 of the heat exchanger device 1 such that the elastocaloric elements 11 and the heat-conducting elements 12 move cyclically toward one another and away from one another. In the embodiments below, the vibration transmitter 3, which is configured in the same manner, transmits the vibration solely to the elastocaloric elements 11 which then move toward the fixed heat-conducting elements 12, enter into contact therewith, are deformed and then moved away therefrom. In further embodiments, the vibration transmitter 3 can transmit the vibrations alternatively or additionally to the heat-conducting elements 12 such that the latter move. The design and the function of the vibration transmitter will be explained in detail in connection with the further FIGS. 2 to 4.

Furthermore, sensors 4 are provided which measure the frequency of the mechanical vibrations of the vibrating unit 2, a force transmitted by the vibrating unit 2, an elongation exerted on elastocaloric elements 11 and/or a travel distance. The arrangement of said sensors and the function are likewise explained in conjunction with the further FIGS. 2 to 4. An electronic computer device 5 is connected to the vibration transmitter 3 and to the sensors 4 and to the vibrating unit 2 and controls the heat exchanger system with the aid of variables measured by the sensors 4. For example, the cycles in which the heat transport means 21 is conveyed are set synchronously to the vibrations which have been emitted by the vibrating unit 2 and transmitted by the vibration transmitter 3.

FIGS. 2 to 5 show three embodiments of the vibration transmitter 3. The same reference signs indicate identical components; the latter will be explained in detail only once. In these embodiments, the heat-conducting elements 12 are fixed and the elastocaloric elements 11 are moved. In further embodiments, the vibration transmitter of which is configured in the same manner, the elastocaloric elements 11 are fixed and the heat-conducting elements 12 are moved. Although, for illustrative reasons, only one elastocaloric element 11 is illustrated in these figures, the description is intended to apply, however, to one elastocaloric element 11, to a plurality of elastocaloric elements 11 or to all of the elastocaloric elements 11 of the heat exchanger device.

FIG. 2 shows a first embodiment of the vibration transmitter 3 which has a mechanical transmission element in the form of a spring element 300. This embodiment is particularly readily suitable if the vibrating unit 2 generates regular vibrations having an identical amplitude and identical frequency. The spring element 300 is selected in accordance with the requirements demanded of the heat transport device 1 and the parameters of the regular vibration. For this case, an additional control in the vibration transmitter 3 is unnecessary. The mechanical vibrations of the vibrating unit 2 that are deflected in the direction of the spring element 300 are absorbed by the spring element 300 and transmitted by the latter linearly to a transmission element 301. The spring element 300 additionally serves here as a damping element for damping the forces which arise during the transmission of the vibration. A first sensor 41 is provided which measures the force transmitted to the spring element 300 and the frequency of the transmitted vibrations. The transmission element 301 is connected to the elastocaloric element 11. In the event of a deflection of the spring element 300, the movement is transmitted by means of the transmission element 301 to the elastocaloric element 11. A stop 302 is provided for the spring element 300, the stop limiting the deflection of the spring element 300 to a provided travel distance. If the spring element 300 elongates because of the vibration, the elastocaloric element 11 is moved by the provided travel distance in the direction of a heat-conducting element 12, not illustrated here, and comes into contact therewith. If the spring element 300 contracts, the elastocaloric element 11 is moved in the opposite direction. The travel distance of the movement of the elastocaloric element 11 and/or the deformation of the elastocaloric element 11 are/is measured by a second sensor 42.

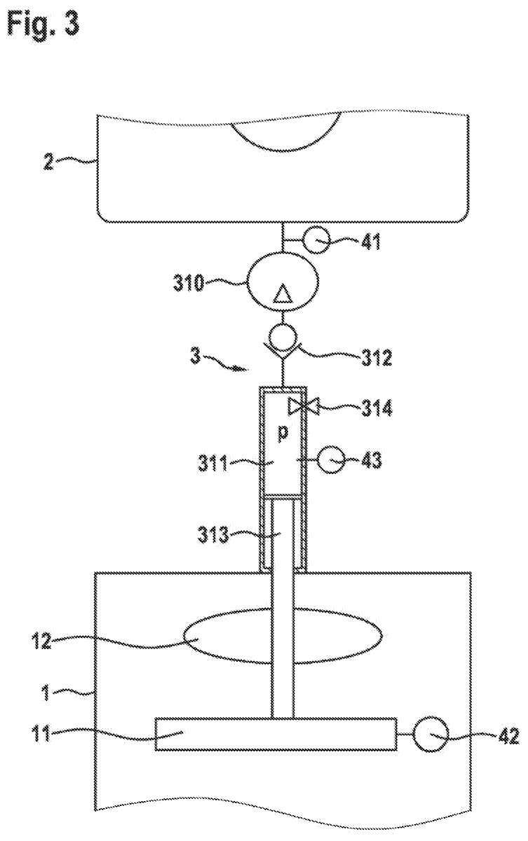

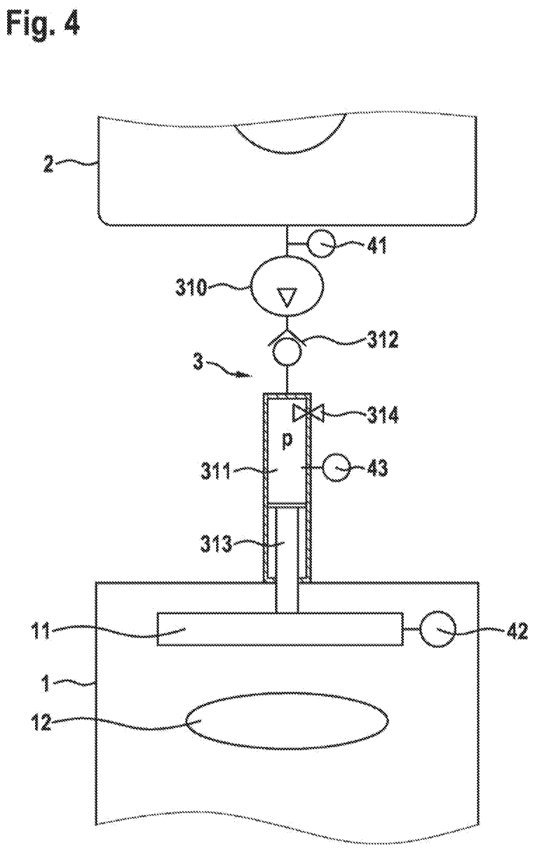

FIGS. 3 and 4 show a second and a third embodiment of the vibration transmitter 3 which in each case has a pump 310 with which the pressure p in a pressure cylinder 311 can be changed. These embodiments are particularly readily suitable if the vibrating unit 2 generates irregular vibrations with a varying amplitude and different frequency. In the second exemplary embodiment regarding FIG. 3, the pump 310 is operated by the mechanical vibrations of the vibrating unit 2 and generates a negative pressure in the pressure cylinder 311 step by step. A nonreturn valve 312 is provided in order to control the change in the pressure p. In other words, each small vibration (in the direction suitable for operating the pump) leads to a decrease in the pressure p, said decreases in total finally resulting in a desired negative pressure. The pressure p in the pressure cylinder is measured by means of a pressure sensor 41. From a predeterminable negative pressure, a linearly movable transmission element 313 which is connected to the elastocaloric element 11 is pulled into the pressure cylinder 311, and therefore the elastocaloric element 11 is moved toward the heat-conducting element 12 and comes into contact therewith. In a third exemplary embodiment in FIG. 4, instead of the negative pressure, a positive pressure is generated in the pressure cylinder 311. By means of the positive pressure, the transmission element 313 is moved out of the pressure cylinder 311. The elastocaloric element 11 is also moved here toward the heat-conducting element 12 and comes into contact therewith. The pressure p in the pressure cylinder 311 is subsequently equalized again via a relief valve 314 on the pressure cylinder 311 and the transmission element 313 is moved again back into its starting position. In both embodiments, the pump 310 and the relief valve 314 can be adjusted or controlled by means of the measured pressure.

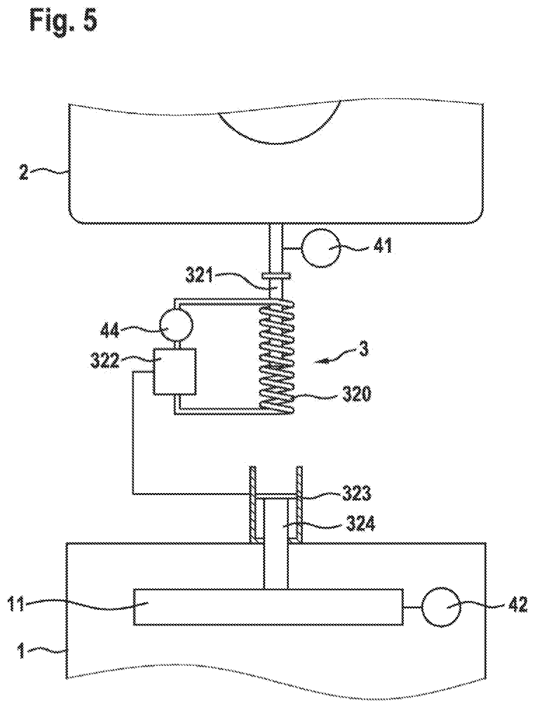

FIG. 5 shows a fourth embodiment of the vibration transmitter 3 which has a coil 320 and a permanent magnet 321, which convert the vibrations into electrical work, and an actuator 323. This embodiment is likewise particularly readily suitable if the vibrating unit 2 generates irregular vibrations having a varying amplitude and different frequency. The mechanical vibrations of the vibrating unit 2 that are deflected in the direction of the permanent magnet 321 are transmitted to the permanent magnet 321 which is then moved into the interior of the coil 320 and/or moved out of the latter. The changing magnetic flux induces a voltage which is measured by a voltage measurement device 44. An electrical energy resulting from the induced voltage is stored in an energy store 322, for example in a battery. Accordingly, the energy stored 322 is also charged by small vibrations which move the permanent magnet 321 only over a short distance. The electrical energy from the energy store 322 is used in order to operate an actuator 323 which comprises a transmission element 324 which is connected to the elastocaloric element 11, wherein the actuator 323 can be adjusted or controlled with the aid of the sensors 41, 42, 44. The actuator 323 moves the transmission element 324 such that the elastocaloric element 11 is moved cyclically in the direction of a heat-conducting element 12, not illustrated, and comes into contact therewith and is then moved in the opposite direction.

1. A heat exchanger system, comprising:
a heat exchanger device comprising elastocaloric elements made of elastocaloric material, the heat exchanger device configured to move the elastocaloric elements in such a manner that the elastocaloric elements are deformed such that an elastocaloric effect is achieved;
a vibrating unit which generates mechanical vibrations; and
a vibration transmitter arranged between the vibrating unit and the heat exchanger device, the vibration transmitter transmitting the mechanical vibrations of the vibrating unit to the elastocaloric elements so as to move the elastocaloric elements.

2. The system as claimed in claim 1, wherein:
the heat exchanger device further comprises heat-conducting elements;
the heat exchanger device is configured to move the elastocaloric elements and the heat-conducting elements toward one another, as a result of which the elastocaloric elements come into contact with the heat-conducting elements and are deformed such that an elastocaloric effect is achieved, and/or to move said elastocaloric elements away from one another; and
the vibration transmitter transmits the vibrations of the vibrating unit at least to the elastocaloric elements such that the elastocaloric elements and the heat-conducting elements move toward one another and/or move away from one another.

3. The system as claimed in claim 1, wherein the vibration transmitter comprises mechanical transmission elements.

4. The system as claimed in claim 3, wherein the vibration transmitter comprises a travel distance limiter which limits a deflection of the vibrations to a travel distance provided for operation of the heat exchanger device.

5. The system as claimed in claim 3, wherein the vibration transmitter comprises a damping element configured to damp forces which arise during the transmission of the vibration.

6. The system as claimed in claim 1, wherein the vibration transmitter comprises a pressure changing device.

7. The system as claimed in claim 1, wherein the vibration transmitter comprises;
a conversion device configured to convert the vibrations into electrical work; and
at least one actuator which converts the electrical work into a movement of the elastocaloric elements.

8. The system as claimed in claim 1, further comprising:
sensors which measure at least one of a frequency of the mechanical vibrations of the vibrating unit, a force transmitted by the vibrating unit, an elongation exerted on the elastocaloric elements, and a travel distance.

9. The system as claimed in claim 1, wherein the vibration transmitter is configured to convert a frequency of the mechanical vibrations of the vibrating unit into a frequency suitable for operating the heat exchanger device.

10. The system as claimed in claim 9, wherein the vibration transmitter is configured to convert the frequency of the mechanical vibrations of the vibrating unit into a resonant frequency of the heat exchanger device.

11. A heat pump comprising:
a heat exchanger system comprising:
a heat exchanger device comprising elastocaloric elements made of elastocaloric material, the heat exchanger device configured to move the elastocaloric elements in such a manner that the elastocaloric elements are deformed such that an elastocaloric effect is achieved;
a vibrating unit which generates mechanical vibrations; and
a vibration transmitter arranged between the vibrating unit and the heat exchanger device, the vibration transmitter transmitting the mechanical vibrations of the vibrating unit to the elastocaloric elements so as to move the elastocaloric elements.
